(19) United States
(12) Patent Application Publication
(10) Pub. No.: US 2006/0235918 A1
(43) Pub. Date: Oct. 19, 2006

(54) Apparatus and method to form a transform

(76) Inventor: Ada Shuk Yan Poon, San Leandro, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/025,581

(22) Filed: Dec. 29, 2004

(51) Int. Cl. G06F 17/14

(52) U.S. Cl. 708/403

(57) ABSTRACT

An apparatus, in some embodiments, includes a one-port memory and a transform unit coupled to the one-port memory. A method, in some embodiments, includes interleaving reading data points for a first data signal from a memory location with writing data points for a second data signal to the memory location, and processing the first data signal to form a transform of the first data signal and processing the second data signal to form a transform of the second data signal.

### FIELD

The subject matter relates to signal processing, and more particularly, to forming signal transforms.

### BACKGROUND

Transforms, such as the Fourier transform, are used to process signals. Some exemplary types of signals processed using transforms include communication signals, radar signals, and sonar signals. Algorithms used to generate transforms can require a large number of computations to generate a single transform. The computations are sometimes performed using integrated circuits, such as digital signal processors or other digital integrated circuits. Integrated circuit based transform systems consume power in performing the computations. Because power is expensive, engineers continually seek ways to reduce power consumption in signal processing systems. In addition to being expensive, for mobile systems that operate on batteries or other power sources that require replacement or recharging, power consumption affects the length of time a system can operate without maintenance. Users desire systems that are inexpensive to operate and that operate for a long period of time before maintenance is required. Thus, it is desirable to have signal processing apparatus, methods, and systems that consume as little power as possible.

### BRIEF DESCRIPTION OF THE DRAWINGS

FIG. 1 is a block diagram of an apparatus including a one-port memory and a transform unit in accordance with some embodiments.

FIG. 2 is a block diagram of an integrated circuit memory suitable for use in connection with the apparatus, shown in FIG. 1, in accordance with some embodiments.

FIG. 3 is a block diagram of a dynamic random access memory suitable for use in connection with the apparatus, shown in FIG. 1, in accordance with some embodiments.

FIG. 4 is a detailed block diagram of the apparatus, shown in FIG. 1, including a dynamic random access memory, shown in FIG. 3, a shift register, a transform computation unit, and a delay unit in accordance with some embodiments.

FIG. 5 is a schematic diagram a configurable shift register suitable for use in connection with the apparatus, shown in FIG. 4, in accordance with some embodiments.

FIG. 6 is a schematic diagram of a self-configurable shift register suitable for us in connection with the apparatus, shown in FIG. 4, in accordance with some embodiments.

FIG. 7 is a flow graph of a butterfly computation unit suitable for use in connection with the apparatus, shown in FIG. 4, in accordance with some embodiments.

FIG. 8 is an illustration of information organization in the one-port memory, shown in FIG. 4, in accordance with some embodiments.

FIG. 9 is an illustration of streaming information received at the shift register from the one-port memory, shown in FIG. 4, of the apparatus, shown in

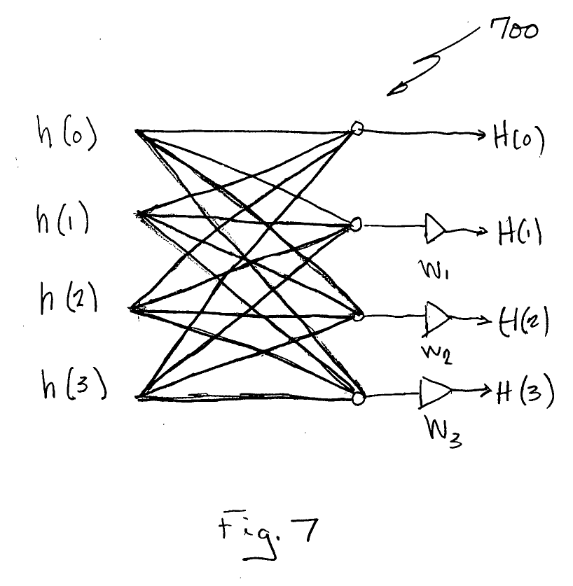

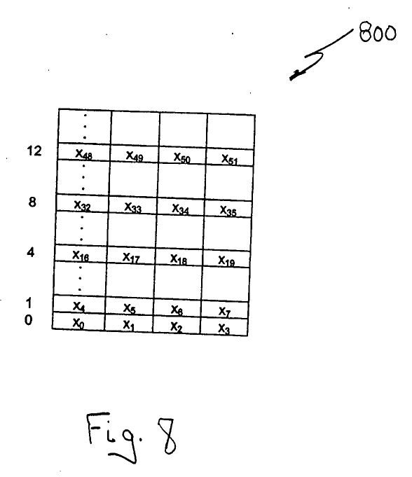

FIG. 4, and transmitted by the shift register after reordering in accordance with some embodiments.

FIG. 10 is a table that illustrates the timing for processing two 64-point data signals in accordance with some embodiments.

FIG. 11 is a flow diagram of a method to form a transform of a first data signal and a transform of a second data signal in accordance with some embodiments.

FIG. 12 is a block diagram of an apparatus including a memory, a programmable information storage unit, and a transform computation unit, shown in FIG. 4, in accordance with some embodiments.

FIG. 13 is a flow diagram of a method to form a transform of a data signal in accordance with some embodiments.

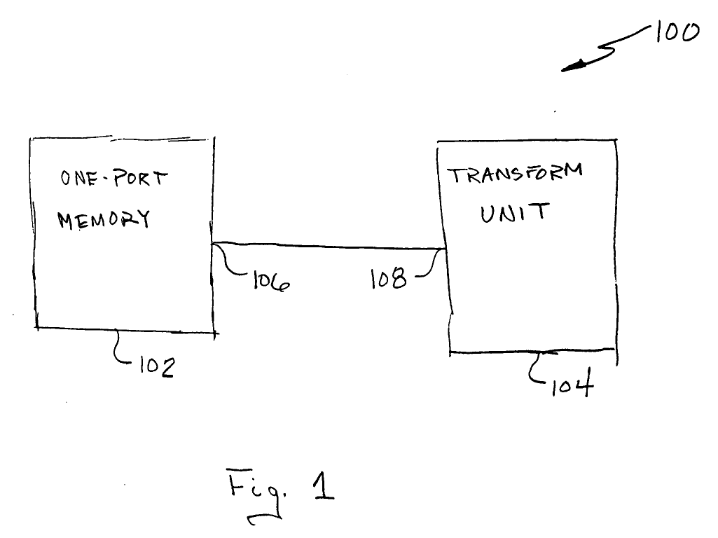

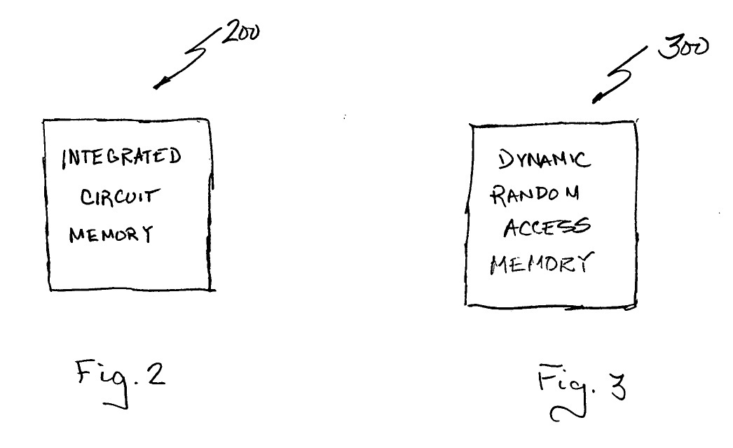

FIG. 14 is a block diagram of a system including a communication unit, a monopole antenna, a one-port memory, shown in FIG. 1, and a transform unit, shown in FIG. 1, in accordance with some embodiments.

FIG. 15 is an illustration of a handset suitable for use in connection with the system, shown in FIG. 14, in accordance with some embodiments.

FIG. 16 is an illustration of a mobile computing unit suitable for use in connection with the system, shown in FIG. 14, in accordance with some embodiments.

### DESCRIPTION

In the following description of some embodiments of the invention, reference is made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable those skilled in the art to practice embodiments of the invention. Other embodiments may be utilized and structural, logical, and electrical changes may be made without departing from the scope of the invention. The following detailed description is not to be taken in a limiting sense, and the scope of the invention is defined only by the appended claims, along with the full scope of equivalents to which such claims are entitled.

FIG. 1 is a block diagram of an apparatus 100 including a one-port memory 102 and a transform unit 104 in accordance with some embodiments. The one-port memory 102 includes a port 106 to receive and transmit information. The transform unit 104 includes a port 108 to receive and transmit information. The port 108 of the transform unit 104 is coupled to the port 106 of the one-port memory 102. The one-port memory 102, by having the port 106 to both receive and transmit information, consumes less power during operation than a memory that includes multiple ports. Less power is consumed in a one-port memory than in a multi-port memory because fewer circuits and control signals are required in a one-port memory than in a multi-port memory.

The one-port memory 102 is not limited to a particular type of memory. In some embodiments, the one-port memory 102 includes an integrated circuit memory. An exemplary integrated circuit memory suitable for use in connection with the apparatus 100 includes a random access memory. A random access memory is accessed with an address and has a latency independent of the address. In some embodiments, the one-port memory 102 includes a dynamic random access memory. A dynamic random access memory includes charge stored on a floating capacitor to store information. In some embodiments, the one-port memory 102 includes a static random access memory. A static random access memory includes a feedback circuit to store information.

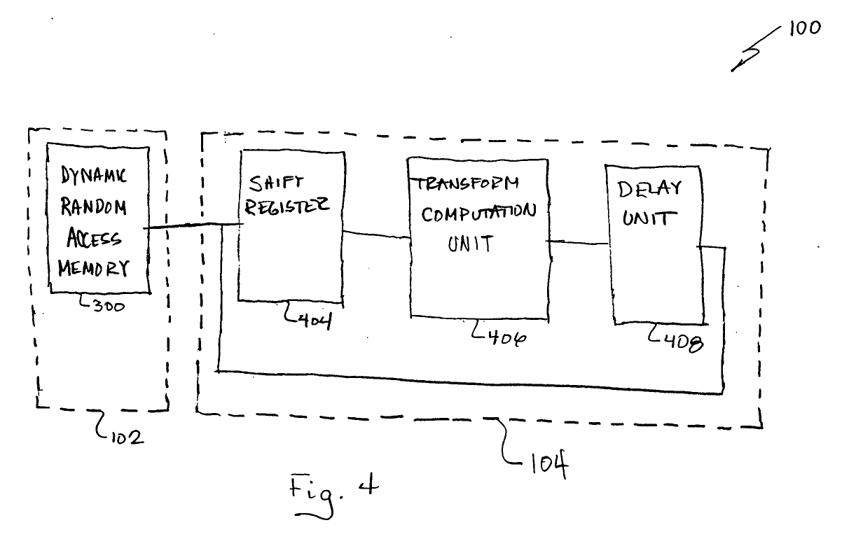

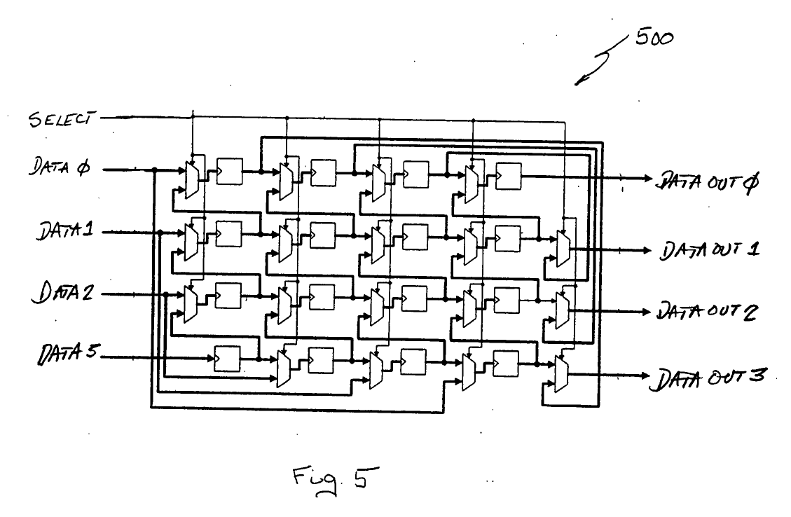

FIG. 2 is a block diagram of an integrated circuit memory 200 suitable for use in connection with the apparatus 100, shown in FIG. 1, in accordance with some embodiments. In some embodiments, the one-port memory 102, shown in FIG. 1, includes the integrated circuit memory 200. An integrated circuit is a circuit in which the circuit connections and the circuit elements are formed on the same substrate. For example, a dynamic random access memory includes connections and circuit elements formed on the same substrate, such as a silicon die.

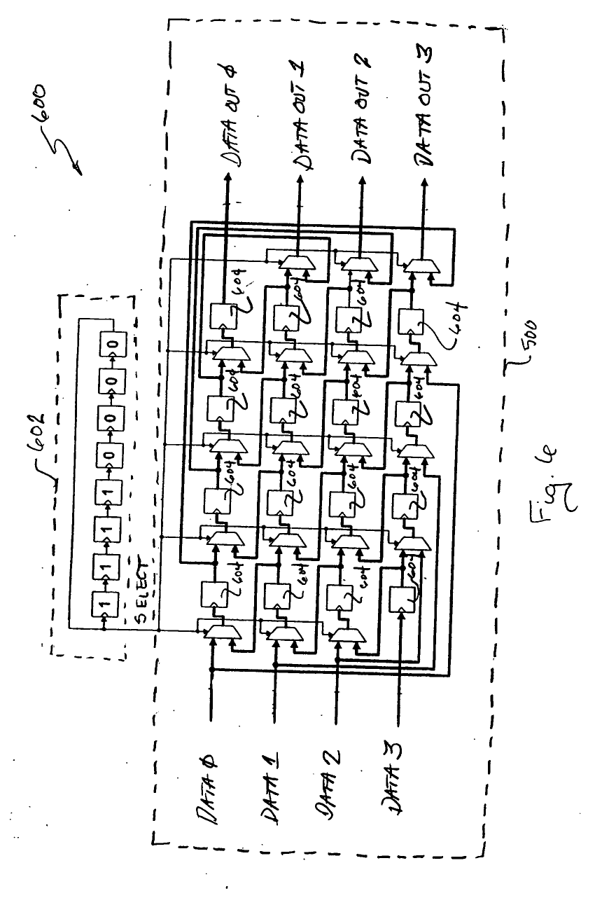

FIG. 3 is a block diagram of a dynamic random access memory 300 suitable for use in connection with the apparatus 100, shown in FIG. 1, in accordance with some embodiments. In some embodiments, the one-port memory 102 includes the dynamic random access memory 300. As noted above in the description of FIG. 2, a dynamic random access memory includes charge stored on a floating capacitor to store information.

Referring again to FIG. 1, the transform unit 104 is not limited to performing a particular type of transform. An exemplary transform unit suitable for use in connection with the apparatus 100 performs the discrete Fourier transform. The Fast Fourier transform is one method of evaluating the discrete Fourier transform. In some embodiments, the transform unit 104 transforms data by processing the data using the Fast Fourier transform. In some embodiments, the transform unit 104 includes a radix-4 butterfly to perform the Fast Fourier transform. A radix-4 butterfly can include four additions and three multiples.

In operation, the one-port memory 102 of the apparatus 100 stores a data signal. The transform unit 104 forms a transform of the data signal and stores the transform in the one-port memory 102. For example, for a 64-point data signal and the transform unit 104 that includes a radix-4 butterfly, the transform unit 104 cyclically processes the 64-point data signal. In each of the sixteen cycles to process the 64-point data signal, the radix-4 butterfly processes four data points of the 64-point data signal.

FIG. 4 is a detailed block diagram of the apparatus 100, shown in FIG. 1, including a dynamic random access memory 300, shown in FIG. 3, a shift register 404, a transform computation unit 406, and a delay unit 408 in accordance with some embodiments. The one-port memory 102 includes the dynamic random access memory 300. The transform unit 104 includes the shift register 404, the transform computation unit 406, and the delay unit 408. The dynamic random access memory 300 is coupled to the shift register 404. The shift register 404 is coupled to the transform computation unit 406. The transform computation unit 406 is coupled to the delay unit 408. And the delay unit 408 is coupled to the dynamic random access memory 300 and the shift register 404. The apparatus 100 is useful in the implementation of multiple-input multiple-output systems, such as in orthogonal frequency division multiplexing systems, in which n (the number of spatial channels) Fast Fourier transforms are performed before spatial processing and channel decoding.

The dynamic random access memory 300 includes a port to access the storage elements of the memory. The width of the port depends on the size of the butterfly included in the transform unit 104. For a 64-point Fast Fourier transform using a radix-4 algorithm, four complex data words are needed from memory for each butterfly computation. To save power, the access port of the dynamic random access memory 300 should be wide enough to allow four complex data words to be read from memory.

The shift register 404 includes a configuration of electronic devices that provide the ability to store, reorganize, and delay information. For example, a plurality of serially connected information storage elements, such as flip-flops, connected for simultaneous clocking can store and delay information. Providing a controllable path from one flip-flop to either of two other flip-flops or gating devices in the shift register 404 enables reorganizing the information. A dual-ported random access memory including counters to designate where data is to be read and written can also store, reorganize, and delay information.

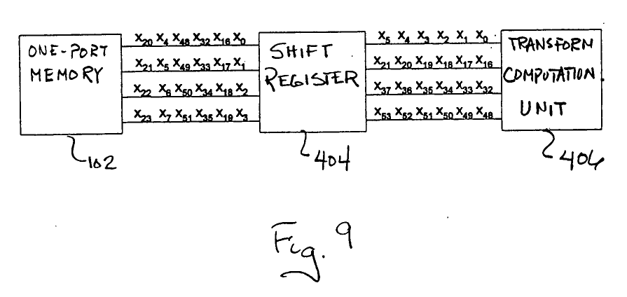

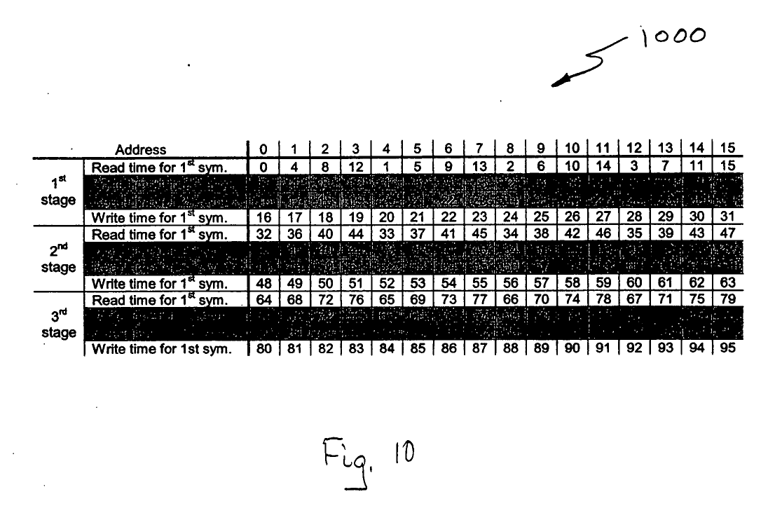

FIG. 5 is a schematic diagram of a configurable shift register 500 suitable for use in connection with the apparatus 100, shown in FIG. 4, in accordance with some embodiments. Referring again to FIG. 4, in some embodiments, the shift register 404 includes the configurable shift register 500, shown in FIG. 5. Referring again to FIG. 5, the configurable shift register 500 includes a control signal, SELECT, for reordering the information included in signals DATA 0, DATA 1, DATA 2, and DATA 3. To reorder the information different information paths in the configurable shift register 500 are enabled. Thus, the output information included in the signals DATA OUT 0, DATA OUT 1, DATA OUT 2, and DATA OUT 3 is a reordered version of the data-stream of input information included in the signals DATA 0, DATA 1, DATA 2, and DATA 3.

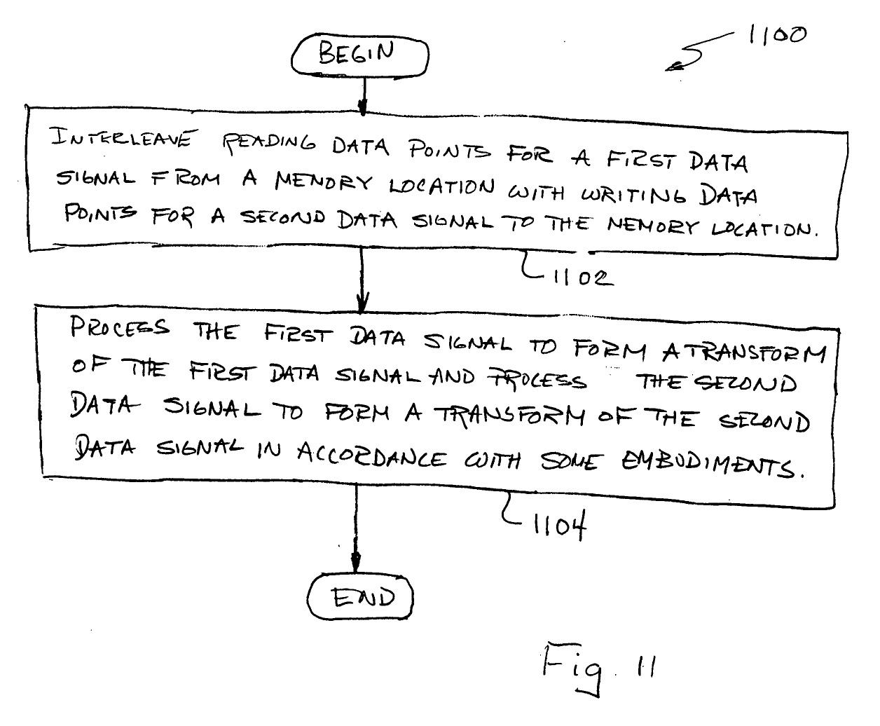

FIG. 6 is a schematic diagram of a self-configurable shift register 600 suitable for us in connection with the apparatus, shown in FIG. 4, in accordance with some embodiments. The self-configurable shift register 600 includes the configurable shift register 500, shown in FIG. 5, and a routing control unit 602 to provide the SELECT signal to the configurable shift register 500. The routing control unit 602 includes control information that allows the SELECT signal to enable and disable paths within the self-configurable shift register 600. In some embodiments, the shift register 404, shown in FIG. 4, includes the self-configurable shift register 600.

The self-configurable shift register 600 includes information storage elements 604. The information storage elements 604 are interconnected such that the four input data streams provided as signals DATA 0, DATA 1, DATA 2, and DATA 3 can be shifted along paths defined by the interconnections between the information storage elements 604. The paths along which the input data streams are shifted are controlled by the SELECT signal provided by the routing control unit 602. In the first four cycles, input streams are shifted along the a first path. In the second four cycles, the input streams are shifted along the second path. Thus, shifting alternates between two paths.

Referring again to FIG. 4, the transform computation unit 406 provides a transform computation. For example, in some embodiments, the transform computation unit 406 provides a Fast Fourier transform computation by including a butterfly, such as a radix-4 butterfly. The critical path in the radix-4 butterfly consists of three additions and one multiplication. In some embodiments, the radix-4 butterfly includes a five-stage pipelined data path. One pipelined stage is included for each addition. Two pipelined stages are included for the multiplication.

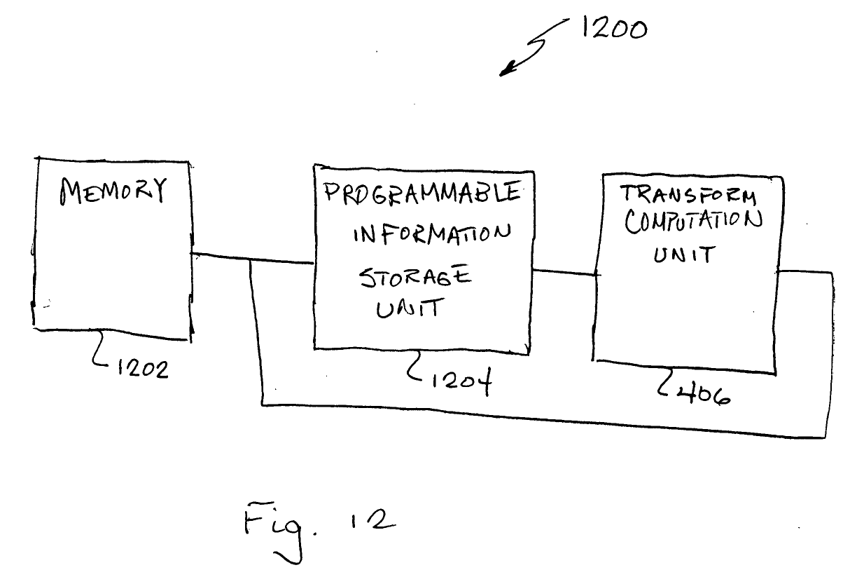

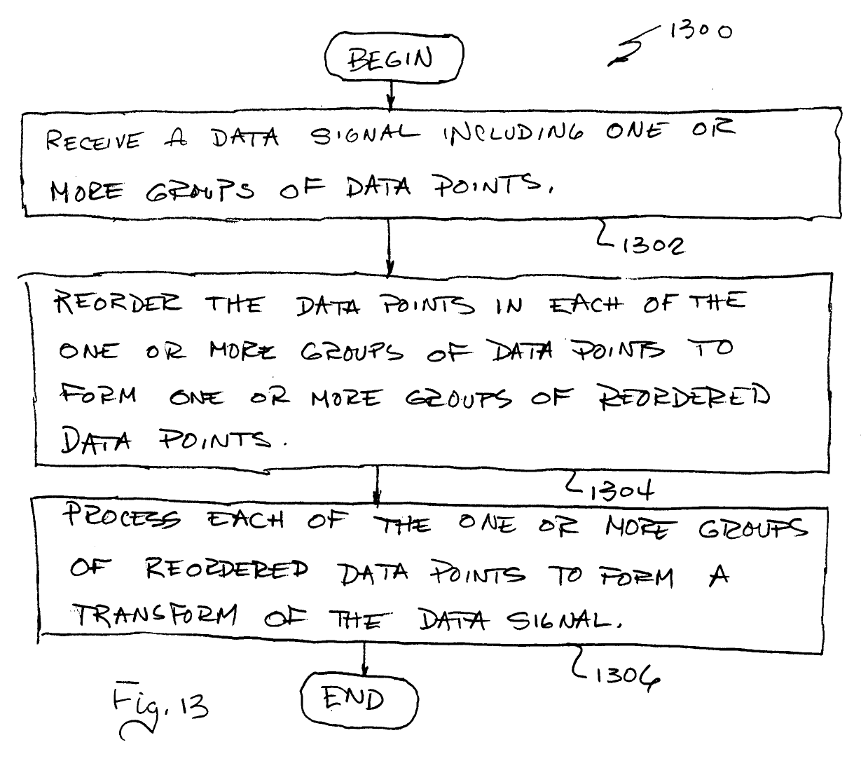

FIG. 7 is a flow graph 700 of a butterfly computation unit suitable for use in connection with the apparatus 100, shown in FIG. 4, in accordance with some embodiments. In some embodiments, the transform computation unit 406, shown in FIG. 4, includes a butterfly computation unit having the operating characteristics of the flow graph 700 that illustrates one embodiment of a radix-4 Fast Fourier transform butterfly.

Referring again to FIG. 4, the delay unit 408 provides a time delay for information passing through the delay unit 408. The delay enables substantially simultaneous reading and writing of information in the one-port memory 102. In some embodiments, the delay unit 408 provides a delay of six delay units. An exemplary delay unit suitable for use in connection with the apparatus 100 includes a plurality of serially connected inverters.

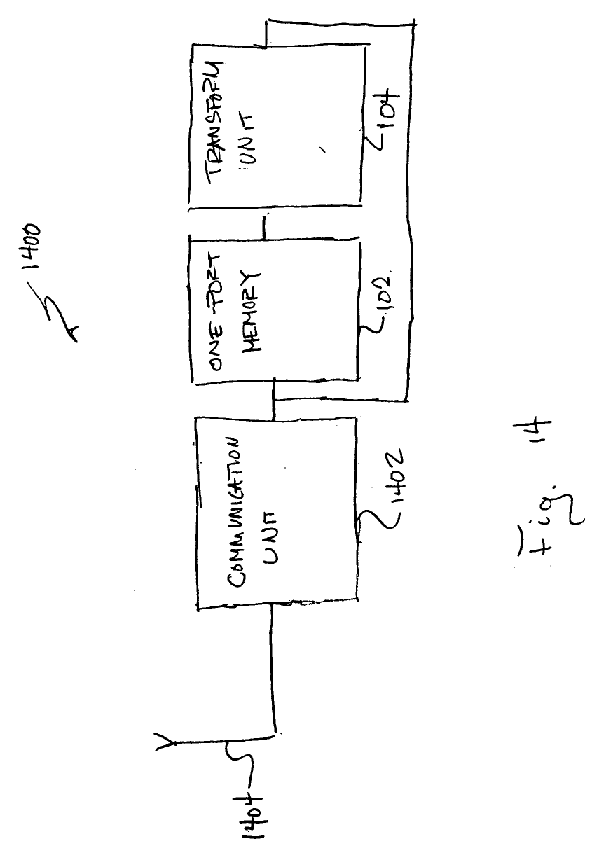

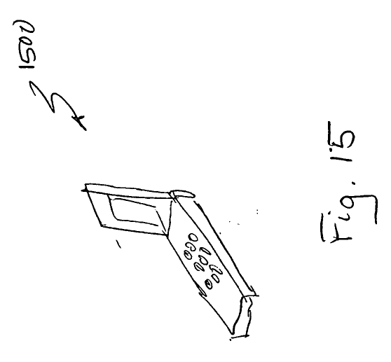

FIG. 8 is an illustration of information organization in the one-port memory 102, shown in FIG. 4, in accordance with some embodiments. Exemplary information at addresses 0, 1, 2, 4, 8, and 12 is shown.

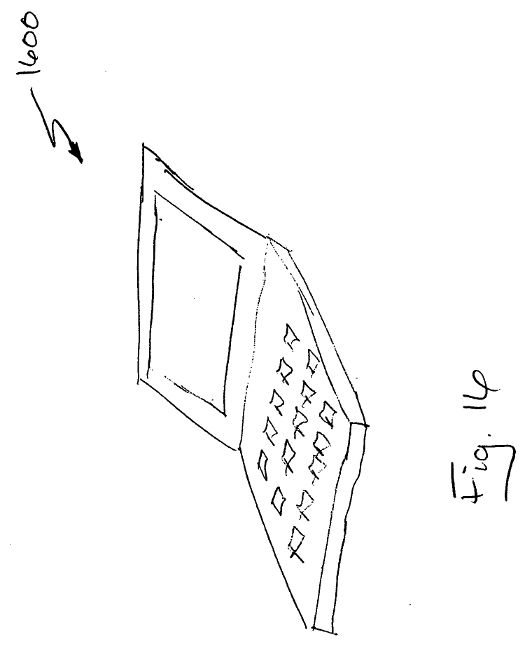

FIG. 9 is an illustration of streaming information received at the shift register 404 from the one-port memory 102, shown in FIG. 4, of the apparatus 100, shown in FIG. 4, and transmitted by the shift register 404 after reordering in accordance with some embodiments. After the information is reordered by the shift register 404, the information is processed by the transform computation unit 406. As can be seen in FIG. 9, the information is reordered for processing before being provided to a radix-4 butterfly included in the transform computation unit 406. The apparatus 100 is not limited to processing information including a particular number of data points. The one-port memory 102, the shift register 404, and the transform computation unit 406 can each be modified to process information having any number of data points.

FIG. 10 is a table 1000 that illustrates the timing for processing two 64-point data signals in accordance with some embodiments. After the data for the first signal is read out from memory location 0 at time 0, the data for the second signal is written to the same memory location. After 16 cycles, the output of the first signal begins to write back to the memory. Simultaneously, the data for the second signal is read out to a butterfly or pipeline to begin the reordering and butterfly operations. By interleaving the memory access of the two signals, concurrent read and write addresses are the same. Consequently, a one-port memory is sufficient to process the two 64-point data signals. Further, a one-port memory is more energy efficient than a multi-port memory. The latency for two Fast Fourier transforms in the interleaving approach is 96+16 or 112 cycles. Compared to the non-interleaving approach the saving is 15%. Thus, interleaving improves utilization of the butterfly or pipeline.

Referring again to FIG. 4, the delay unit 408 is added at the output of the transform computation unit 406 to delay memory write-back by six cycles. Together with the latency of one cycle for memory read, four cycles at the shift registers for data reordering, and five cycles at the transform computation unit 406, the total latency is sixteen cycles. During these sixteen cycles, the second signal can be written to the same memory locations.

FIG. 11 is a flow diagram of a method 1100 to form a transform of a first data signal and a transform of a second data signal in accordance with some embodiments. The method 1100 includes interleaving reading data points for a first data signal from a memory location with writing data points for a second data signal to the memory location (block 1102), and processing the first data signal to form a transform of the first data signal and processing the second data signal to form a transform of the second data signal (block 1104).

In some embodiments, the method 1100 includes interleaving reading data points for a first data signal from a memory location with writing data points for a second data signal to the memory location, and processing the first data signal to form a transform of the first data signal and processing the second data signal to form a transform of the second data signal.

In some embodiments of the method 1100, processing the first data signal to form the transform of the first data signal and processing the second data signal to form the transform of the second data signal includes cyclically processing the data points for the first data signal and cyclically processing the data points for the second data signal.

In some embodiments of the method 1100, cyclically processing the data points for the first data signal and cyclically processing the data points for the second data signal includes reading the data points for the first data signal from the memory location and reordering the data points before processing the data points through a butterfly computation.

FIG. 12 is a block diagram of an apparatus 1200 including a memory 1202, a programmable information storage unit 1204, and the transform computation unit 406, shown in FIG. 4, in accordance with some embodiments. The programmable information storage unit 1204 is coupled to the memory 1202. The transform computation unit 406 is coupled to the programmable information storage unit 1204 and the memory 1202.

A memory 1202 is not limited to a particular type of memory. Exemplary memories suitable for use in connection with the apparatus 1200 include random access memories, such as dynamic random access memories.

The programmable information storage unit 1204 includes data paths that are selectable. In some embodiments, the programmable information storage unit 1204 includes a shift register. In some embodiments, the shift register, such as the shift register 404, shown in FIG. 4, includes a storage element connected to at least two other storage elements. Exemplary storage elements include flip-flops or random access memory storage. In some embodiments, the programmable information storage unit includes a self-configured shift register.

In operation, the memory 1202 stores data points representing a data signal. The programmable information storage unit 1204 receives and reorders the data points. The transform computation unit 406 processes the data points to form a transform of the data signal.

FIG. 13 is a flow diagram of a method 1300 to form a transform of a data signal in accordance with some embodiments. The method 1300 includes receiving a data signal including one or more groups of data points (block 1302), reordering the data points in each of the one or more groups of data points to form one or more groups of reordered data points (block 1304), and processing each of the one or more groups of reordered data points to form a transform of the data signal (1306).

In some embodiments, processing each of the one or more groups of reordered data points to form a transform of the data signal includes processing each of the one or more groups of reordered data points through a Fourier Transform algorithm. In some embodiments, processing each of the one or more groups of reordered data points to form a transform of the data signal includes processing each of the one or more groups of reordered data points in a radix-4 butterfly.

FIG. 14 is a block diagram of a system 1400 including a communication unit 1402, a monopole antenna 1404, the one-port memory 102, shown in FIG. 1, and the transform unit 104, shown in FIG. 1, in accordance with some embodiments. The one-port memory 102 is coupled to the communication unit 1402. The transform unit 104 is coupled to the one-port memory 102. In some embodiments the transform unit 104 includes a delay unit.

The communication unit 1402 processes a signal received at the monopole antenna 1404 to form a processed signal and stores the processed signal in the one-port memory 102. For example, the communication unit 1402 processes an analog signal received at the monopole antenna 1404 by converting the received analog signal to a digital signal for storage in the one-port memory 102. In some embodiments, the communication unit 1402 is a receiver. A receiver detects and receives information. In some embodiments, the communication unit 1402 is a transceiver. A transceiver transmits and receives information.

In operation, the monopole antenna 1404 receives a signal The signal is stored in the one-port memory 102. The transform unit 104 transforms the signal stored in the one-port memory 102. In some embodiments, the transform unit 104 transforms the signal using the method 1000 shown in FIG. 10.

FIG. 15 is an illustration of a handset 1500 suitable for use in connection with the system 1400, shown in FIG. 14, in accordance with some embodiments. Exemplary handsets include personal digital assistants, cell phones, and handheld games. In some embodiments, the communication unit 1402, shown in FIG. 14, includes the handset 1500.

FIG. 16 is an illustration of a mobile computing unit 1600 suitable for use in connection with the system 1400, shown in FIG. 14, in accordance with some embodiments. Exemplary mobile computing units include notebook computers, handheld computers, and personal digital assistants. In some embodiments, the communication unit 1402, shown in FIG. 14, includes the mobile computing unit 1600.

Although specific embodiments have been described and illustrated herein, it will be appreciated by those skilled in the art, having the benefit of the present disclosure, that any arrangement which is intended to achieve the same purpose may be substituted for a specific embodiment shown. This application is intended to cover any adaptations or variations of the invention. Therefore, it is intended that this invention be limited only by the claims and the equivalents thereof.

What is claimed is:

1. An apparatus comprising:
a one-port memory; and
a transform unit coupled to the one-port memory.

2. The apparatus of claim 1, wherein the one-port memory comprises an integrated circuit memory.

3. The apparatus of claim 2, wherein the integrated circuit memory comprises a dynamic random access memory.

4. The apparatus of claim 1, wherein the transform unit comprises:
a shift register coupled to the one-port memory;
a transform computation unit coupled to the shift register; and
a delay unit coupled to the transform computation unit and to the one-port memory.

5. The apparatus of claim 4, wherein the shift register comprises a configurable shift register.

6. The apparatus of claim 5, wherein the configurable shift register comprises a self-configurable shift register.

7. The apparatus of claim 4, wherein the transform computation unit comprises a butterfly computation unit.

8. The apparatus of claim 4, wherein the delay unit provides a delay of six delay units.

9. A method comprising:
interleaving reading data points for a first data signal from a memory location with writing data points for a second data signal to the memory location; and
processing the first data signal to form a transform of the first data signal and processing the second data signal to form a transform of the second data signal.

10. The method of claim 9, wherein processing the first data signal to form the transform of the first data signal and processing the second data signal to form the transform of the second data signal comprises cyclically processing the data points for the first data signal and cyclically processing the data points for the second data signal.

11. The method of claim 10, wherein cyclically processing the data points for the first data signal and cyclically processing the data points for the second data signal comprises reading the data points for the first data signal from the memory location and reordering the data points before processing the data points through a butterfly computation.

12. An apparatus comprising:
a memory to store data points representing a data signal;
a programmable information storage unit coupled to the memory, the programmable information storage unit to receive and reorder the data points; and
a transform computation unit coupled to the programmable information storage unit, the transform computation unit to process the data points to form a transform of the data signal.

13. The apparatus of claim 12, wherein the programmable information storage unit comprises a shift register.

14. The apparatus of claim 13, wherein the shift register comprises a storage element connected to at least two other storage elements.

15. The apparatus of claim 14 herein the programmable information storage unit comprises a self-configured shift register.

16. The apparatus of claim 12, wherein the transform computation unit comprises a Fast Fourier transform computation unit.

17. The apparatus of claim 12, wherein the computation unit comprises a Fourier Transform computation unit.

18. The apparatus of claim 12, wherein the transform computation unit comprises a butterfly computation unit.

19. A method comprising:
receiving a data signal including one or more groups of data points;
reordering the data points in each of the one or more groups of data points to form one or more groups of reordered data points; and
processing each of the one or more groups of reordered data points to form a transform of the data signal.

20. The method of claim 19, wherein processing each of the one or more groups of reordered data points to form the transform of the data signal comprises processing each of the one or more groups of reordered data points through a Fourier Transform algorithm.

21. The method of claim 19, wherein processing each of the one or more groups of reordered data points to form the transform of the data signal comprises processing each of the one or more groups of reordered data points through a radix-4 butterfly.

22. A system comprising:
a communication unit including a monopole antenna;
a one-port memory coupled to the communication unit; and
a transform unit coupled to the one-port memory.

23. The system of claim 22, wherein the communication unit comprises a handset.

24. The system of claim 22, wherein the communication unit comprises a mobile computing unit.

25. The system of claim 22, wherein the transform unit comprises a delay unit.

26. The system of claim 22, wherein the transform unit comprises a Fast Fourier transform unit.
